(19) United States
(12) Patent Application Publication
(10) Pub. No.: US 2015/0363423 A1
(43) Pub. Date: Dec. 17, 2015

(54) METHOD AND SYSTEM FOR PARALLEL DATA REPLICATION IN A DISTRIBUTED FILE SYSTEM

(71) Applicant: Telefonaktiebolaget L M Ericsson (publ), Stockholm (SE)

(72) Inventors: Anant P. Utgikar, Bangalore (IN); Prasanna Huddar, Banglore (IN); P. Govinda Rajulu, Bangalore (IN); Sikkander Ismail, Bangalore (IN)

(21) Appl. No.: 14/302,300

(22) Filed: Jun. 11, 2014

(51) Int. Cl. G06F 17/30; H04L 29/08

(52) U.S. Cl. CPC G06F 17/30212; H04L 67/1095; H04L 67/02

(57) ABSTRACT

Methods and systems are described for redundant storage of a data block from a data source into a distributed file system over a software-defined network. According to one embodiment, the methods and system describe a cloud manager in the network that identifies a first and second storage server in a network, along with the clusters that the servers are in, and the in-cluster network elements (NEs) of those clusters. The cloud manager calculates best paths through the NEs of the network to reach the identified storage servers, reserves bandwidth along the best paths so that the data block can be sent, configures the forwarding tables of the NEs in these best paths to forward the data block to the storage servers, and sends the data block through the best paths.

### FIELD

Embodiments of the invention relate to the field of distributed file systems; and more specifically, to distributed file systems within split architecture programmable or software-defined networks.

### BACKGROUND

Unlike the traditional network architecture, which integrates both the forwarding (data) and the control planes in the same box (network element); a split architecture network decouples these two planes and executes the control plane on servers that might be in different physical locations from the forwarding elements (switches). The use of a split architecture in a network enables the simplification of the switches implementing the forwarding plane and shifts the intelligence of the network into a number of controllers that oversee the switches.

The tight coupling of the forwarding and control planes in a traditional architecture usually results in an overly complicated control plane and complex network management. This is known to create a large burden and high barrier to new protocols and technology developments. Despite the rapid improvement of line speeds, port densities, and performance, the network control plane mechanisms have advanced at a much slower pace than the forwarding plane mechanisms.

In a split architecture network, controllers collect information from switches, and compute and distribute the appropriate forwarding decisions to switches. Controllers and switches use a protocol to communicate and exchange information. An example of such protocol is OpenFlow (see www.openflow.org), which provides an open and standard method for a switch to communicate with a controller.

Typical distributed file systems depend on keeping multiple copies of data in order to safeguard against data loss in the event of a storage disk failure. This is typically referred to as redundant storage. Generally, it is recommended that a distributed file system store three copies of the same data, on three different storage servers, with at least one copy of the data on a separate server cluster to safeguard against failure of a server cluster.

One prior art technique for redundant storage is to first store the data that is to be redundantly stored on a storage server, then replicate it by sending a copy from that server to the other servers that are to serve as redundant storage server for the data. This approach can at times be inefficient, slow, and bandwidth-intensive.

### SUMMARY

A method for redundant storage of a data block from a data source across a plurality of storage servers in a distributed file system implemented by a cloud manager system within a programmable or software-defined network is described. The network contains a plurality of network elements (NEs) and a plurality of clusters, each cluster includes a subset of the plurality of storage servers and an in-cluster NE that is coupled to each of the subset of storage servers in the cluster, and the cloud manager communicates with the NEs using a split architecture protocol. The method includes identifying a first storage server and a second storage server in the network, wherein the both storage servers have sufficient storage space to store the data block. The method also includes identifying a first cluster and a second cluster in the network, such that the first cluster includes the first storage server and a first in-cluster NE, and the second cluster includes the second storage server and a second in-cluster NE. The method also includes calculating a first best path from the data source to the first in-cluster NE, through a first subset of the plurality of NEs in the network. The method also includes calculating a second best path from the data source to the second in-cluster NE, through a second subset of the plurality of NEs in the network. The method also includes reserving bandwidth along the first and second best paths for the data block to be sent. The method also includes configuring the forwarding table of the first in-cluster NE to forward incoming data to the first storage server. The method also includes configuring the forwarding table of each NE in the first subset to forward data to the next NE in the first best path. The method also includes configuring the forwarding table of the second in-cluster NE to forward incoming data to the second storage server. The method also includes configuring the forwarding table of each NE in the second subset to forward data to the next NE in the second best path. The method also includes sending the data block through the first best path and the second best path to be stored in both the first storage server and the second storage server.

A non-transitory machine-readable storage medium that stores instructions is described. The instructions may be executed by a processor of a cloud manager system, the cloud manager system used for redundant storage of a data block from a data source across a plurality of storage servers in a distributed file system within a programmable or software-defined network. The network contains a plurality of network elements (NEs) and a plurality of clusters. Each cluster includes a subset of the plurality of storage servers and an in-cluster NE that is coupled to each of the subset of storage servers in the cluster. The cloud manager communicates with the NEs using a split architecture protocol. When the instructions are executed by the processor of the cloud manager system, the instruction will cause said processor to perform operations.

The operations include identifying a first storage server and a second storage server in the network, wherein the both storage servers have sufficient storage space to store the data block. The operations also include identifying a first cluster and a second cluster in the network, such that the first cluster includes the first storage server and a first in-cluster NE, and the second cluster includes the second storage server and a second in-cluster NE. The operations also include calculating a first best path from the data source to the first in-cluster NE, through a first subset of the plurality of NEs in the network. The operations also include calculating a second best path from the data source to the second in-cluster NE, through a second subset of the plurality of NEs in the network. The operations also include reserving bandwidth along the first and second best paths for the data block to be sent. The operations also include configuring the forwarding table of the first in-cluster NE to forward incoming data to the first storage server. The operations also include configuring the forwarding table of each NE in the first subset to forward data to the next NE in the first best path. The operations also include configuring the forwarding table of the second in-cluster NE to forward incoming data to the second storage server. The operations also include configuring the forwarding table of each NE in the second subset to forward data to the next NE in the second best path. The operations also include sending the data block through the first best path and the second best path to be stored in both the first storage server and the second storage server.

A cloud manager system for redundant storage of a data block from a data source across a plurality of storage servers in a distributed file system is described, the cloud manager system within a programmable software-defined network. The network contains a plurality of network elements (NEs) and a plurality of clusters of storage servers. Each cluster is coupled to an in-cluster NE, and the cloud manager communicates with the NEs using a split architecture protocol. The cloud manager system includes a data store and a processor coupled to the data store. The processor is operable to execute a cloud storage identifier. The cloud storage identifier is operable to identify a first storage server and a second storage server in the network, wherein the both storage servers have sufficient storage space to store the data block, and to identify a first cluster and a second cluster in the network, such that the first cluster includes the first storage server and a first in-cluster NE, and the second cluster includes the second storage server and a second in-cluster NE. The processor is further operable to execute a data sender, the data sender operable to calculate a first best path from the data source to the first in-cluster NE, through a first subset of the plurality of NEs in the network. The data sender is further operable to calculate a second best path from the data source to the second in-cluster NE, through a second subset of the plurality of NEs in the network. The data sender is further operable to reserve bandwidth along the first and second best paths for the data block to be sent. The data sender is further operable to configure the forwarding table of the first in-cluster NE to forward incoming data to the first storage server. The data sender is further operable to configure the forwarding table of each NE in the first subset to forward data to the next NE in the first best path. The data sender is further operable to configure the forwarding table of the second in-cluster NE to forward incoming data to the second storage server. The data sender is further operable to configure the forwarding table of each NE in the second subset to forward data to the next NE in the second best path. The data sender is further operable to send the data block through the first best path and the second best path to be stored in both the first storage server and the second storage server.

### BRIEF DESCRIPTION OF THE DRAWINGS

The invention may best be understood by referring to the following description and accompanying drawings that are used to illustrate embodiments of the invention. In the drawings:

FIG. 1 illustrates one exemplary embodiment of the connectivity between the cloud manager 101, data source 191, and network elements (NEs) in an exemplary network.

FIG. 2A illustrates one exemplary embodiment of the cloud manager 101 with integrated name node 103 and network controller 105.

FIG. 2B illustrates one exemplary embodiment of the cloud manager 101 with external name node 103 and network controller 105.

FIG. 3 is a flow diagram illustrating one embodiment of a method for redundant storage of a data block across a plurality of storage servers in a distributed file system.

FIG. 4A illustrates one exemplary embodiment of data tracking information as viewable by the cloud manager 101 and name node 103.

FIG. 4B illustrates one exemplary embodiment of host tracking information as viewable by the cloud manager 101 and network controller 105.

FIG. 4C illustrates one exemplary embodiment of link statistic information as viewable by the cloud manager 101 and network controller 105.

FIG. 5A illustrates one embodiment of connectivity between network devices (NDs) within an exemplary network, as well as three exemplary implementations of the NDs.

FIG. 5B illustrates one embodiment of an exemplary way to implement the special-purpose network device 502.

FIG. 5C illustrates various exemplary ways, in some embodiments, in which virtual network elements (VNEs) may be coupled.

FIG. 5D illustrates one embodiment of a network with a single network element (NE) on each of the NDs of FIG. 5A, and within this straight forward approach contrasts a traditional distributed approach (commonly used by traditional routers) with a centralized approach for maintaining reachability and forwarding information (also called network control).

FIG. 5E illustrates one embodiment of the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D.

FIG. 5F illustrates one embodiment of a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D.

FIG. 6 illustrates one embodiment of a general purpose control plane device 604 including hardware 640 comprising a set of one or more processor(s) 251 (which are often Commercial off-the-shelf (COTS) processors) and network interface controller(s) 644 (NICs; also known as network interface cards) (which include physical NIs 646), as well as non-transitory machine readable storage media 253 (or in some embodiments, 203) having stored therein centralized control plane (CCP) software 650).

### DESCRIPTION OF EMBODIMENTS

The following description describes methods and apparatus for redundant storage of a data block across a plurality of storage servers in a distributed file system. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

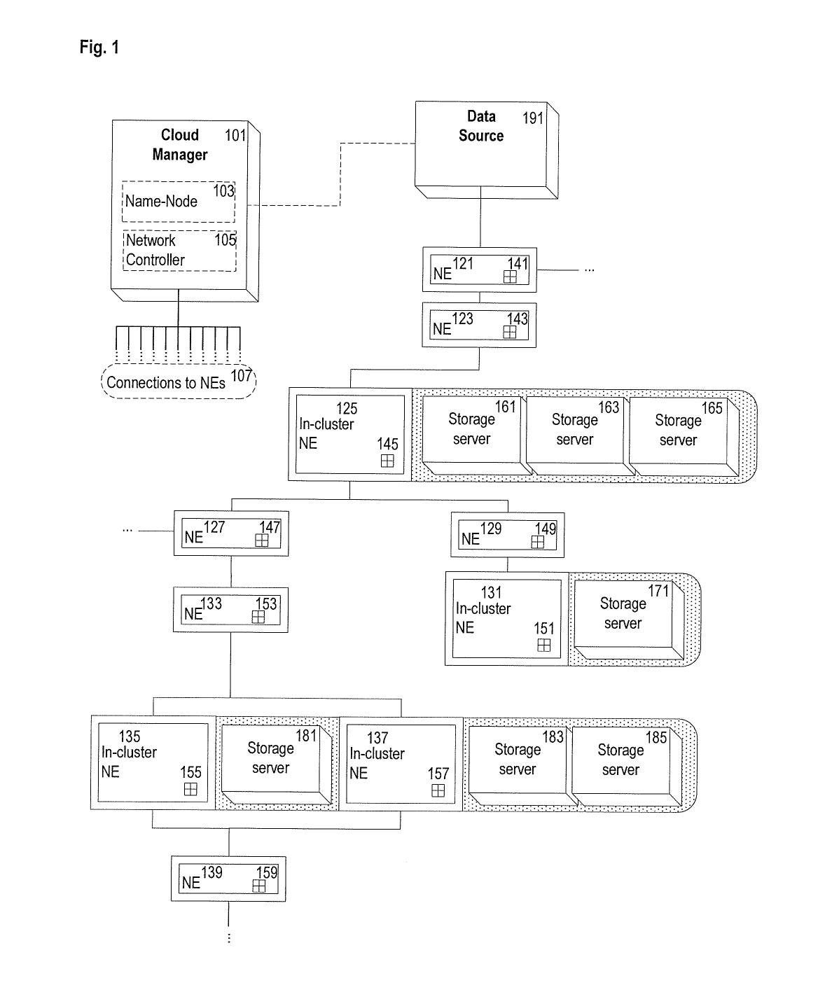

FIG. 1 illustrates one exemplary embodiment of the connectivity between the cloud manager 101, data source 191, and network elements (NEs) in an exemplary network. The data source 191 typically connects to the remainder of the network via one or more of the NEs, such as NE 121 as depicted in the exemplary network of FIG. 1. The NEs include in-cluster NEs (e.g. 125, 131, 135), each of which can forward data to the storage servers (e.g. 161, 163, 165, 171, 181, 183, 185) within the cluster that it is located within.

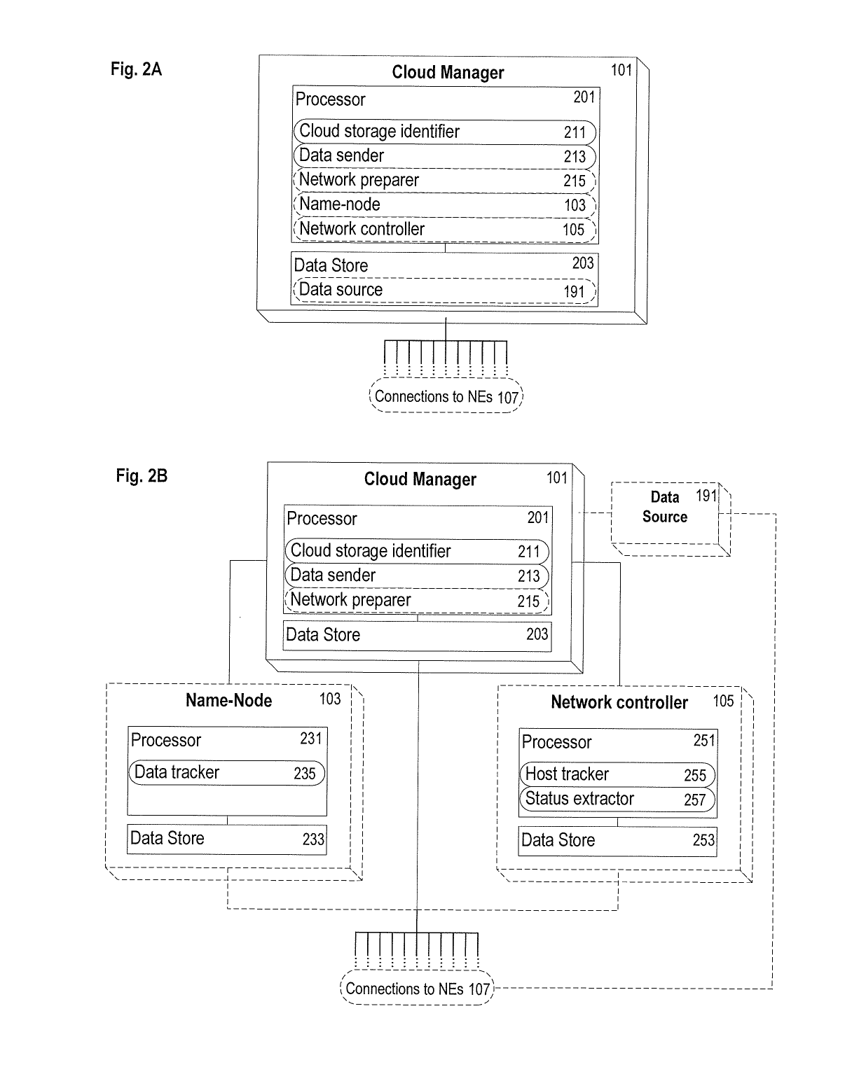

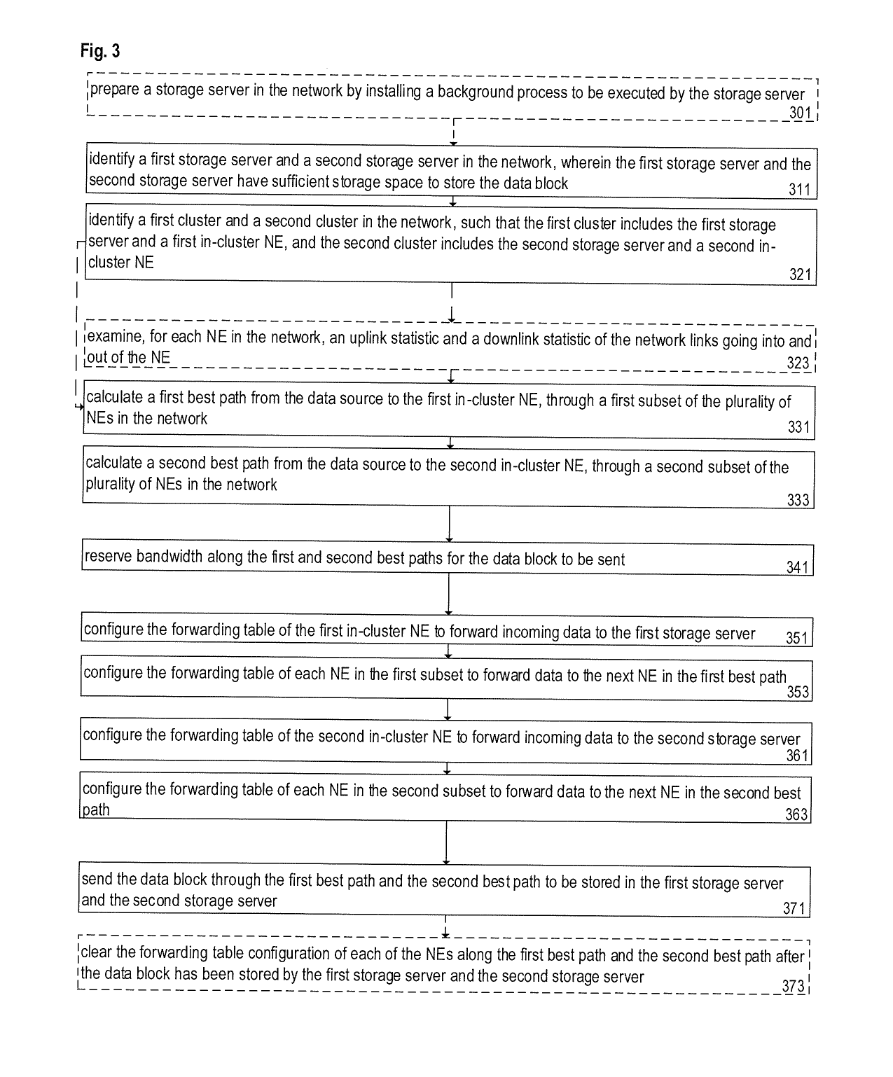

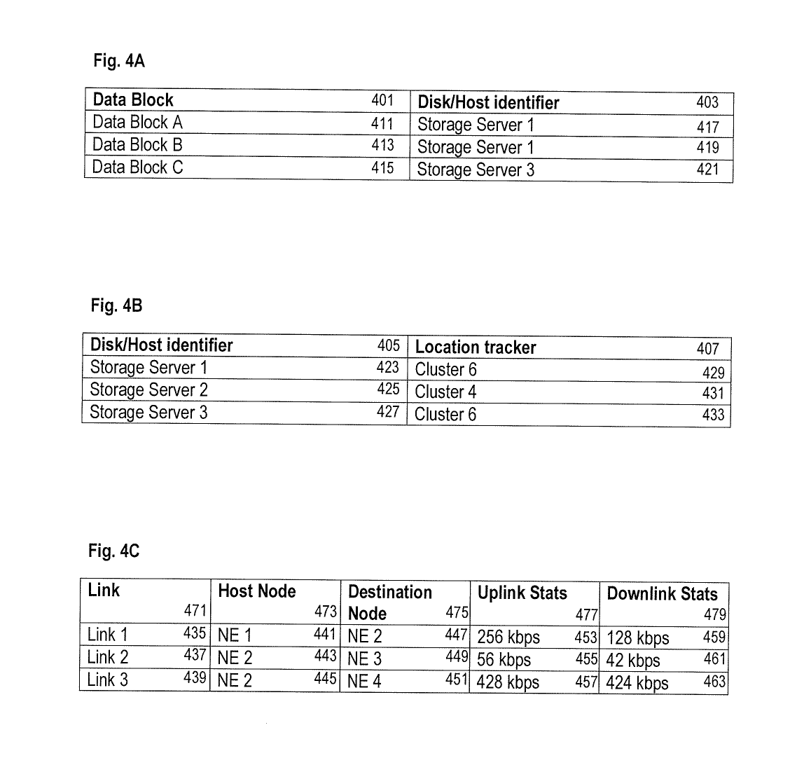

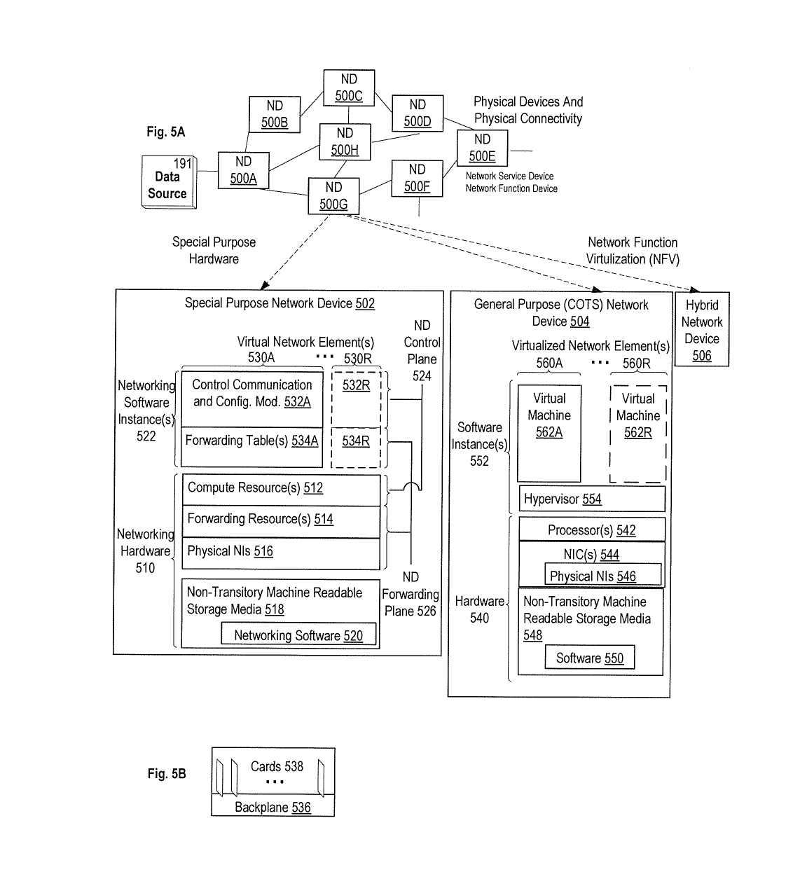

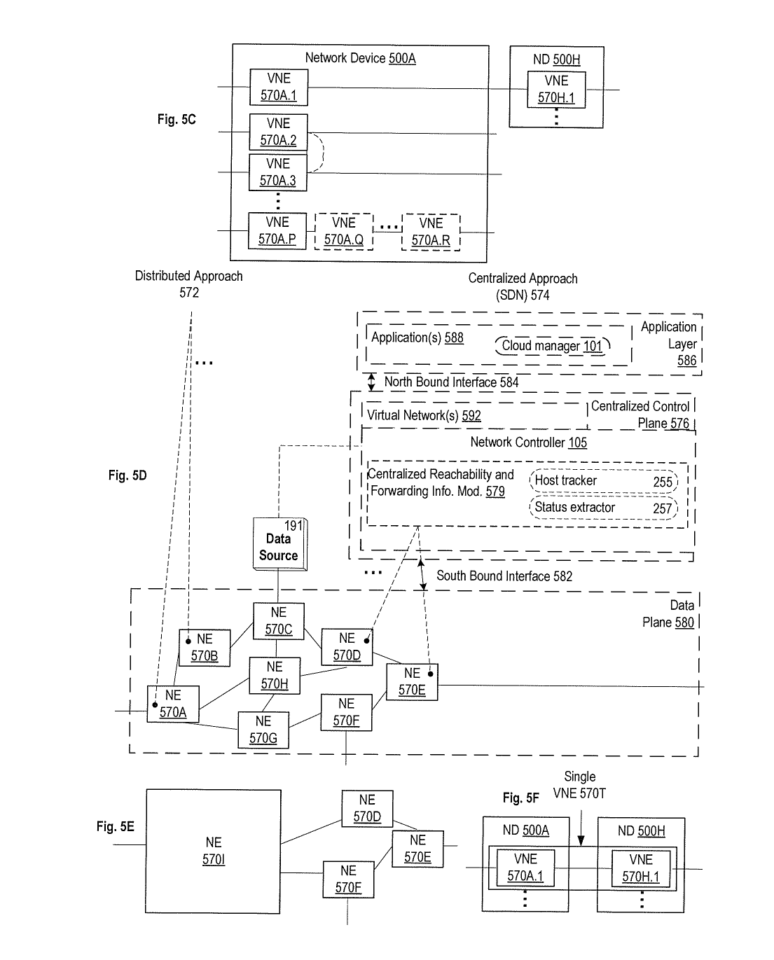

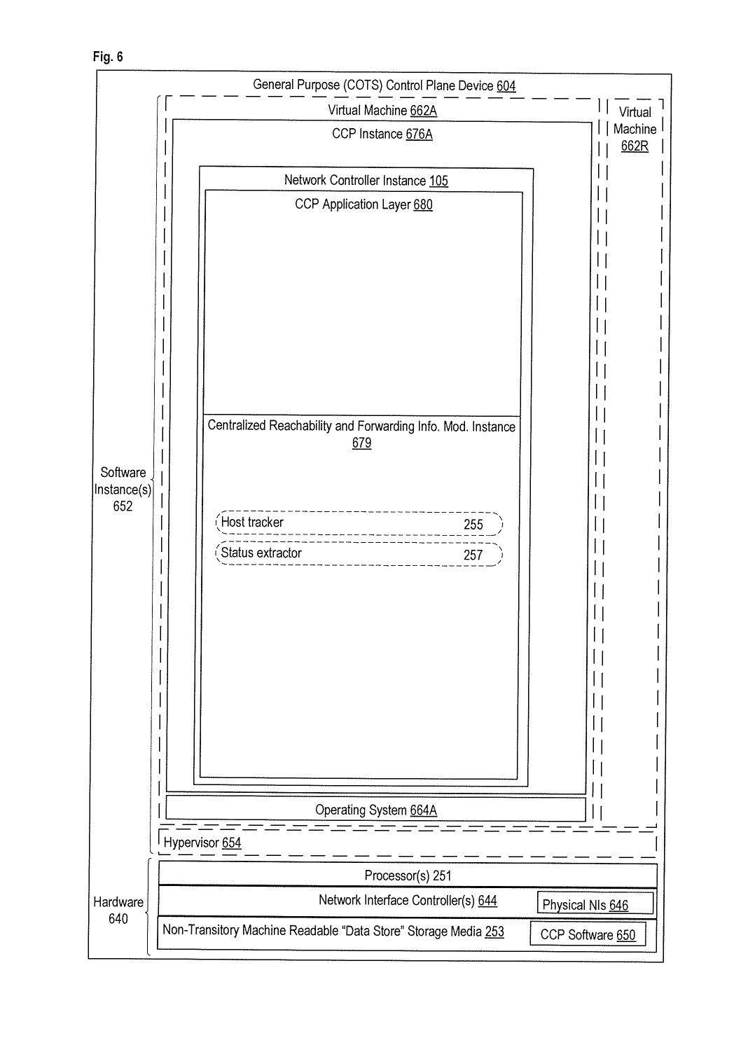

A cloud manager 101 is also included in the network. The cloud manager 101 gathers information about the storage servers in the network, the data stored on the storage servers in the network, the NEs in the network, and the forwarding tables in the network. The cloud manager 101 is also operable to configure the forwarding tables of the NEs in the network. Two implementations of the cloud manager 101 are illustrated in FIG. 2A and FIG. 2B. The functionality of the cloud manager 101 is further described in relation to FIG. 3. FIG. 4A, FIG. 4B, FIG. 4C, FIG. 5D, and FIG. 6. The cloud manager 101 is connected to NEs, as noted in block 107. In some embodiments, the cloud manager is connected to every NE in the network. In other embodiments, the cloud manager 101 is connected to a subset of the NEs in the network. In some embodiments, the cloud manager 101 is connected to the data source 191. Such connections can be over Hypertext Transfer Protocol (HTTP), Hypertext Transfer Protocol Secure (HTTPS), File Transfer Protocol (FTP), Transport Layer Security (TLS), Secure Sockets Layer (SSL), User Datagram Protocol (UDP), Simple Mail Transfer Protocol (SMTP), Wireless Application Protocol (WAP), Bluetooth, or another appropriate communications or security protocol.

In some embodiments, the cloud manager 101 includes a name node 103, a network controller 105, a data source 191, or some combination thereof. The name-node 103 is a data-tracking entity typically used in distributed file systems, such as the Hadoop Distributed File System (HDFS), General Parallel File System (GPFS), Common Internet File System (CIFS), Network File System (NFS). The network controller 105 is an entity typically used in split architecture networks, i.e., networks in which the control plane is separated from the data plane. The data source 191 may be any type of device capable of storing or sending data. These elements are further described in reference to FIG. 2A and FIG. 2B, which illustrates exemplary configurations of the cloud manager in relation to these elements.

The storage servers (161, 163, 165, 171, 181, 183, 185) are hardware units capable of storing data. In various embodiments, each storage server may be any one of: a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, any other machine with similar functionality. In some embodiments, a storage server includes multiple storage disks or storage disk volumes, while in other embodiments, it contains only one of each. In some embodiments, a storage server can be a “black box” of network-attached storage (NAS). In some embodiments, a storage server can be a “black box” link to a separate distributed file system. In some embodiments, a storage server can be a data storage module without a coupled computer (such as a hard disk drive storage device, an optical drive storage device, a tape drive storage device, a Redundant Arrays of Independent Disks (RAID), a flash memory device, a magneto-optical memory device, a holographic memory device, a memristor-based memory device, a bubble memory device, a magnetic drum device, a memory stick, a polyester film tape, a smartdisk, a thin film memory, a zip drive, or similar storage or memory hardware).

There are multiple network elements (NEs) depicted in FIG. 1. Each NE includes a forwarding table (e.g., forwarding table 141 corresponding to NE 121). NEs are sometimes referred to as switches, forwarding elements, data plane elements, or nodes. In some embodiments, an NE can be implemented by a hardware network device (ND). In some embodiments, one ND can implement multiple virtual network elements (VNEs). A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). NDs, NEs, and VNEs are further described in reference to FIG. 5A, FIG. 5B, FIG. 5C, FIG. 5D, FIG. 5E, and FIG. 5F.

The NEs in the exemplary network of FIG. 1 include in-cluster NEs (e.g., 125, 131, 135, 137), each of which are coupled to a cluster of one or more storage servers. In-cluster NEs can take many forms, some of which are illustrated in FIG. 1. For example, in-cluster NE 125 is an in-cluster NE that is coupled to a cluster of three storage servers (161, 163, 165). In-cluster NE 125 as depicted has a “top-of-cluster” layout that can be common when the cluster is a rack of storage servers. In other embodiments, in-cluster 125 need not be located at the “top” of a cluster, but may instead be located otherwise within the cluster, similarly to in-cluster NE 137 as depicted in FIG. 1 and as discussed further below.

In-cluster NE 131 is coupled only to a single storage server 171. In some embodiments, in-cluster NE 171 is incorporated into the same hardware as storage server 171. In other embodiments, in-cluster NE 131 and storage server 171 are separate hardware units that are coupled together.

Finally, in-cluster NE 135 and in-cluster NE 137 are both coupled to the same cluster of storage servers (181, 183, 185), which in-cluster NE 135 located at the “top” of the cluster and in-cluster NE 137 located between storage server 181 and storage server 183. In some embodiments, this means that in-cluster NE 135 and in-cluster NE 137 are connected to different “regions” of their mutual cluster; i.e., in-cluster NE 135 is connected to storage server 181, while in-cluster NE 137 is connected to storage servers 137. In such an embodiment, in-cluster NE 137 can communicate with in-cluster NE 135 if in-cluster NE 137 has received data intended for storage server 181, and vice versa if the data was intended for storage server 183 or 185. In other embodiments, in-cluster NE 135 and in-cluster NE 137 are not connected to each other. In some embodiments, both, in-cluster NE 135 and in-cluster NE 137 are connected to all of the storage servers in their mutual cluster (181, 183, 185). In FIG. 1, both in-cluster NE 135 and in-cluster NE 137 are connected to NE 133; likewise for NE 139. In alternate embodiments, however, this need not be the case. For example, in one embodiment, in-cluster NE 137 connects to NE 133, but in-cluster NE 135 does not. In another embodiment, the connections diverge, so that in-cluster 135 connects to NE 139 but in-cluster NE 137 connects to another NE (not depicted).

In some embodiments, each in-cluster NE is operable to output data to each of the servers in its cluster via a storage data traffic connection that provides inputs into each storage server in the cluster. In some embodiments, the in-cluster NE is capable of multicasting through the storage data traffic connections so that multiple storage servers in the cluster can be sent the same data approximately simultaneously. Such connections can be over Hypertext Transfer Protocol (HTTP), Hypertext Transfer Protocol Secure (HTTPS), File Transfer Protocol (FTP), Transport Layer Security (TLS), Secure Sockets Layer (SSL), User Datagram Protocol (UDP), Simple Mail Transfer Protocol (SMTP), Wireless Application Protocol (WAP), Bluetooth, or another appropriate communications or security protocol. In some embodiments, the storage servers (e.g., 161, 163, 165) have a second output connection back to the in-cluster NE through which TCP/IP Acknowledgement (ACK) and other similar link traffic can be sent from a storage server to the in-cluster NE upon successful storage of data in the storage server.

The data source 191 may be any type of device. In some embodiments, it may be a server, such as a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, a “blade” server, any other machine with similar functionality. In other embodiments, it may be a different type of device, such as a personal computer (e.g., desktops, laptops, and tablets), a virtual machine, a “thin” client, a personal digital assistant (PDA), a Redundant Arrays of Independent Disks (RAID) array, a network-connected appliance, a file server, a network-connected gaming device, a network device, a media player, a mobile phone (e.g., Smartphone), or any other machine with similar capabilities. In other embodiments, the data source 191 may be a plurality of networked machines, such as from a distributed file system.

In one embodiment, the network is a split architecture software-defined network (SDN). In a split architecture network, controllers collect information from network elements, and compute and distribute the appropriate forwarding configurations to switches. Controllers and switches use a protocol to communicate and exchange information. An example of such protocol is OpenFlow (see www.openflow.org), which provides an open and standard method for a switch to communicate with a controller. Another exemplary protocol that could be used in a different embodiment is the OpFlex protocol by Cisco Systems, Inc. In other embodiments, the network may be another appropriate form of programmable network.

The network is not restricted to linear, non-branching paths. For example, a path from data source 191 to in-cluster NE 125 could continue onward to NE 127, or it could continue onward to NE 129. Similarly, branching links are depicted for NE 121 and NE 127, these links impliedly leading to other NEs (not depicted). The network is also not restricted to the branching tree-like structure depicted in FIG. 1, but can be more interconnected at distant NEs. For example, in some embodiments, the link branching from NE 127 could connect to the link branching from NE 121, and the link continuing from NE 139.

FIG. 2A illustrates one exemplary embodiment of the cloud manager 101 with integrated name node 103, network controller 105, and data source 191. In this embodiment, the cloud manager 101 is comprised of a processor 201 and a data store 203. In some embodiments, additional elements may be included, such as a network adapter, an input device, a display, a printer or other output device, or any one of a number of other elements that are typically found within or coupled to a computer system (additional elements not shown).

The processor 201 of the cloud manager 101 can be a microprocessor, an application-specific integrated circuit (ASIC), a state machine, or other processor, and can be any of a number of computer processors. Such processors include, or may be in communication with, media, for example computer-readable media, which stores instructions that, when executed by the processor, cause the processor to perform the steps described herein. In other embodiments, cloud manager 101 can be distributed over any number of processors or computing systems, or can be implemented in a multi-tenant and/or virtualized environment such as a cloud computing system.

The data store 203 of the cloud manager 101 can include hard disk drive storage, optical drive storage, tape drive storage, random access memory (RAM), read-only memory (ROM), programmable read-only memory (PROM), Redundant Arrays of Independent Disks (RAID), flash memory, magneto-optical memory, holographic memory, memristor-based memory, bubble memory, magnetic drum, memory stick, polyester film tape, smartdisk, thin film memory, zip drive, or similar storage or memory hardware.

The processor 201 of the cloud manager 101 is operable to execute a cloud storage identifier 211 and a data sender 213. In some embodiments, the cloud storage identifier 211 is operable to identify storage servers and clusters in the network (see blocks 311 and 321 in FIG. 3). In some embodiments, the data sender 213 is operable to calculate best paths through the network, reserve bandwidth for a data block to be sent, configure forwarding tables of NEs along the best paths, send the data block, and clear the forwarding tables (see block 323, 331, 333, 341, 351, 353, 361, 363, 371, 373 in FIG. 3). In some embodiments, the cloud manager 101 is also operable to execute a network preparer 215 that prepares storage servers in the network by installing a background process (see block 301 in FIG. 3). In the embodiment of FIG. 2A, the processor 201 is also operable to execute a name-node 103 and a network controller 105.

The name-node 103 is a data-tracking entity typically used in distributed file systems, such as the Hadoop Distributed File System (HDFS), General Parallel File System (GPFS), Common Internet File System (CIFS), Network File System (NFS). The name-node 103 stores information regarding where specific data blocks are stored within the topology of the network, i.e., which data block is stored in which storage server. In some embodiments, the name-node 103 is able to use this information to determine which storage server would be best to use to store a replica of a particular data block for redundancy purposes. FIG. 4A is an exemplary table illustrating some of the information that the name-node 103 can view according to one embodiment. The functionality of the name-node 103 is further described in reference to FIG. 3 and FIG. 4A.

The network controller 105 is an entity typically used in split architecture networks, i.e., networks in which the control plane is separated from the data plane. In such networks, the data plane is typically implemented by a collection of NEs, while the control plane is implemented by a network controller 105. In some embodiments, the network controller 105 is connected to each NE in the network, as depicted in block 107 of FIG. 1 and FIG. 2A and FIG. 2B, and as further detailed in reference to FIG. 5D. The network controller 105 communicates with the NEs using OpenFlow or a similar protocol. In some embodiments, the network controller 105 is operable to locate a particular storage server within the network. For example, in the embodiment illustrated by FIG. 4B, the network controller 105 is operable to view which storage server is located within which cluster. In some embodiments, the network controller 105 is operable to examine, for each NE in the network, an uplink statistic and a downlink statistic of the network links going into and out of the NE (block 323 of FIG. 3), as illustrated by the exemplary link statistics table of FIG. 4C. The functionality of the network controller is further described in reference to FIG. 3, FIG. 4B, FIG. 4C, FIG. 5D, and FIG. 6.

The data source 191, in the embodiment of FIG. 2A, is data that includes the data block to be sent. In the embodiment of FIG. 2A, it is simply included in the data store 203 of the cloud manager 101, but in another embodiment, it could also have a software component running in the processor 201 of the cloud manager 101. In yet another embodiment, the data source 191 could be external from the cloud manager 101, as depicted in FIG. 2B.

FIG. 2B illustrates one exemplary embodiment of the cloud manager 101 with external name node 103 and network controller 105. As with the embodiment illustrated in FIG. 2A, the cloud manager 101 is comprised of processor 201 and a data store 203. In this embodiment, however, the processor 203 does not execute the name-node 103 and the network controller 105; instead, these are executed from their own hardware devices that are in communication with the cloud manager 101 through a network connection. Such a connection can be Hypertext Transfer Protocol (HTTP), Hypertext Transfer Protocol Secure (HTTPS), File Transfer Protocol (FTP), Transport Layer Security (TLS), Secure Sockets Layer (SSL), User Datagram Protocol (UDP), Simple Mail Transfer Protocol (SMTP), Wireless Application Protocol (WAP), Bluetooth, or another appropriate communications or security protocol. In this embodiment, name-node 103 is comprised of processor 231 and data store 233, with processor 231 operable to execute data tracker 235. In this embodiment, network controller 105 is comprised of processor 251 and data store 253, with processor 251 operable to execute host tracker 255 and status extractor 257. In some embodiments, additional elements may be included within cloud manager 101, name-node 103, or network controller 105, the additional elements being, for example, a network adapter, an input device, a display, a printer or other output device, or any one of a number of other elements that are typically found within or coupled to a computer system (additional elements not shown).

The processors 231 and 251, like the processor 201, can be a microprocessor, an application-specific integrated circuit (ASIC), a state machine, or other processor, and can be any of a number of computer processors. Such processors include, or may be in communication with, media, for example computer-readable media, which stores instructions that, when executed by the processor, cause the processor to perform the steps described herein. In other embodiments, cloud manager 101, name-node 103, and network controller 105 can each be distributed over any number of processors or computing systems, or can be implemented in a multi-tenant and/or virtualized environment such as a cloud computing system.

The data stores 233 and 253, like the data store 203, can include hard disk drive storage, optical drive storage, tape drive storage, random access memory (RAM), read-only memory (ROM), programmable read-only memory (PROM), Redundant Arrays of Independent Disks (RAID), flash memory, magneto-optical memory, holographic memory, memristor-based memory, bubble memory, magnetic drum, memory stick, polyester film tape, smartdisk, thin film memory, zip drive, or similar storage or memory hardware.

As noted above, name-node 103 is a data-tracking entity typically used in distributed file systems, such as the Hadoop Distributed File System (HDFS), General Parallel File System (GPFS), Common Internet File System (CIFS), Network File System (NFS). FIG. 4A is an exemplary table illustrating the ability of the name-node 103 to determine the storage server that a particular data block is stored on. If the storage servers include multiple disks or disk volumes, then in some embodiments, the name-node 103 can also discern which disk or disk volume a particular data block is stored on. In one embodiment, this functionality is provided by the data tracker 235, which is executed by the processor 231. The functionality of the name-node 103 is further described in reference to FIG. 3 and FIG. 4A.

As noted above, network controller 105 is an entity typically used in split architecture networks, i.e., networks in which the control plane is separated from the data plane. In such networks, the data plane is typically implemented by a collection of NEs, while the control plane is implemented by a network controller 105. In some embodiments, the network controller 105 is operable to locate a particular storage server within the network. For example, in the embodiment illustrated by FIG. 4B, the network controller 105 is operable to view which storage server is located within which cluster. In one embodiment, this server-locating functionality is provided by the host tracker 255. In some embodiments, the network controller 105 is operable to examine, for each NE in the network, an uplink statistic and a downlink statistic of the network links going into and out of the NE (block 323 of FIG. 3), as illustrated by the exemplary link statistics table of FIG. 4C. In one embodiment, this link-analysis functionality is provided by the status extractor 257. The functionality of the network controller is further described in reference to FIG. 3, FIG. 4B, FIG. 4C, and FIG. 5D.

In the embodiment of FIG. 2B, the data source 191 is external to the cloud manager 101. The data source 191 may be any type of device. In some embodiments, it may be a server, such as a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, a “blade” server, any other machine with similar functionality. In other embodiments, it may be a different type of device, such as a personal computer (e.g., desktops, laptops, and tablets), a virtual machine, a “thin” client, a personal digital assistant (PDA), a Redundant Arrays of Independent Disks (RAID) array, a network-connected appliance, a file server, a network-connected gaming device, a network device, a media player, a mobile phone (e.g., Smartphone), or any other machine with similar capabilities. In other embodiments, the data source 191 may be a plurality of networked machines, such as from a distributed file system. The data source 191 may include its own processor and data store (not pictured), both of which could include the variety of processors and data stores listed in reference to processor 201 or data store 203.

While FIG. 2B depicts the name-node 103, the network controller 105, and the data source 191 being external to the cloud manager 101, in some embodiments, one or more of these is co-located with the cloud manager 101 as depicted in FIG. 2A. Similarly, the name-node 103 could be co-located with the network controller 105, or the name-node 103 could be co-located with the data source 191, or the network controller 105 could be co-located with the data source 191. Any co-locating combination of these entities is possible.

Another embodiment (not pictured) is possible in which the cloud manager is merely an umbrella term used to refer to name-node 103 and network controller 105, rather than being a physical system. In some embodiment, this could also refer to the data source 191.

In addition to the embodiments described in FIG. 2A and FIG. 2B, in some embodiments, the cloud manager 101 is an application running on a guest operating system above a hypervisor, and further wherein the hypervisor is one of (a) a bare metal hypervisor running natively on a server, or (b) a hypervisor running on top of a base operating system. The various forms of the cloud manager 101 described in FIG. 2A and FIG. 2B can be similarly separated or co-located if they are implemented as applications running on a guest operating system above a hypervisor. In particular, in some embodiments, the cloud manager 101, the name-node 103, the network controller 105, the data source 191, or some combination thereof is implemented as an application running on a guest operating system above a hypervisor.

FIG. 3 is a flow diagram illustrating one embodiment of a method for redundant storage of a data block across a plurality of storage servers in a distributed file system. In one embodiment, the process is triggered by an instruction received from the cloud manager 101, the data source 191, a computer system capable of connecting to the cloud manager 101 or data source 191 (not pictured), a user input (not pictured), or some combination thereof.

In some embodiments, the method includes preparing one or more storage servers in the network by installing a background process to be executed by these storage servers (block 301). In one embodiment, the background process is one that manages and organizes data received by the storage server so that it may be effectively stored, duplicated, defragmented, deleted, or sent elsewhere if the storage server receives an instruction to do so from the storage server's in-cluster NE, from the cloud manager 101, from the name-node 103, from the network controller 105, from the data source 191, or some combination thereof. If the storage server includes multiple storage disks or storage disk volumes, then in some embodiments, the background process may additionally manage which data blocks are placed into each storage disk or disk volume, and may relocate data blocks if necessary or if doing so produces an increase in speed or efficiency of data movement. In some embodiments, the background process may delete data, defragment data, duplicate data, send data elsewhere based on a timer, an amount of storage in the storage server, or in a similar automated fashion. In one embodiment, for example, the background process could be introduced from one of the cloud manager 101, the name-node 103, the network controller 105, the data source 191, or some combination thereof. In one embodiment, the background process is installed by the network preparer 215. In one embodiment, every storage server in the network prepared by receiving and executing the background process. In other embodiments, only a subset of the storage servers in the network are prepared.

The method includes identifying a first storage server and a second storage server in the network, wherein both storage servers have sufficient storage space to store the data block (block 311). In some embodiments, the cloud manager 101, the name-node 103, or some combination thereof is used to identify these storage servers. In one embodiment, the identification is performed by the data tracker 235 or cloud storage identifier 211 as further detailed in reference to FIG. 4A. In some embodiments, this identifying process also includes a check and confirmation that each selected storage server has been prepared during step 301. In some embodiments, this identifying process identifies a particular storage disk or disk volume within the first storage server and second storage server, such that these storage disks or disk volumes have sufficient storage space to store the data block.

The method includes identifying a first cluster and a second cluster in the network, such that the first cluster includes the first storage server and a first in-cluster NE, and the second cluster includes the second storage server and a second in-cluster NE (block 321). In some embodiments, the cloud manager 101, the network controller 105, or some combination thereof is used to identify the cluster and in-cluster NE of each of the storage servers. In some embodiments, the identification process includes communication between one or more storage servers or NEs and the cloud manager 101 or network controller 105. In one embodiment, the identification is performed by the host tracker 255 or cloud storage identifier 211 as further detailed in reference to FIG. 4B. In some embodiments, this identifying process also includes a check and confirmation that each of the other storage servers in the cluster has been prepared during step 301.

The method includes calculating a first best path from the data source to the first in-cluster NE, through a first subset of the plurality of NEs in the network (block 331). The method also includes calculating a second best path from the data source to the second in-cluster NE, through a second subset of the plurality of NEs in the network (block 333). In some embodiments, the calculation process includes communication between one or more storage servers or NEs and the cloud manager 101 or network controller 105. In some embodiments, the process of calculating the first and second best paths includes examining, for each NE in the network, an uplink statistic and a downlink statistic of the network links going into and out of the NE (block 323). In some embodiments, the cloud manager 101, the network controller 105, or some combination thereof is used to calculate the best paths. In one embodiment, the calculation of best paths is performed by the host tracker 255, the status extractor 257, the data sender 213, or some combination thereof. In some embodiments, other properties of the links and NEs are taken into account in calculating the best paths, such as link flapping, link stability/volatility, NE firmware/hardware versions, latency, packet loss, link reliability, throughput, link utilization, maximum transmission units (MTU), cost metrics, administrative policy preferences, and similar properties.

The best path calculations of blocks 331 and 333 can be visualized in reference to the exemplary network illustrated in FIG. 1. In one exemplary embodiment, the first storage server is storage server 181, and the second storage server is storage server 171. This results in a first best path and a second best path that start together at data source 191 and overlap until eventually diverging after in-cluster NE 125. If other paths through the network are available, the first best path and second best path need not overlap. For example, if NE 127 connected directly to data source 191 through the link on its left side, then the first path would start at data source 191, then go directly to NE 127, then eventually on to storage server 181 through in-cluster NE 135 or in-cluster NE 137.

In another exemplary embodiment, the second best path may be a subset of the first best path. In one exemplary embodiment, the first storage server is storage server is the storage server 171 of FIG. 1, and the second storage server is the storage server 161 of FIG. 1. This can result in an incoming data packet completing the second best path and continuing onward to complete the first best path. If this is the case, then the forwarding table 145 of the in-cluster NE 125 of FIG. 1 should be configured to perform multicast or multiple-unicast forwarding of incoming data to both the second storage server 161 and onward through the best path to NE 129 and eventually to in-cluster NE 131 and second storage server 171.

The method also includes reserving bandwidth along the first best path and the second best path for the data block to be sent (block 341). In some embodiments, the cloud manager 101, the network controller 105, or some combination thereof is the entity that signals the NEs to reserve bandwidth along the best paths. In some embodiments, the bandwidth-reservation process includes communication between one or more storage servers or NEs and the cloud manager 101 or network controller 105. In one embodiment, the reservation of bandwidth is performed by the host tracker 255, the status extractor 257, the data sender 213, or some combination thereof.

The method also includes configuring the forwarding table of the first in-cluster NE to forward incoming data to the first storage server (block 351). In some embodiments, this includes configuring the forwarding table of the first in-cluster NE to forward incoming data to a specific storage disk or disk volume the first storage server. The method also includes configuring the forwarding table of each NE in the first subset (of the plurality of NEs in the network) to forward data to the next NE in the first best (block 353). In some embodiments, configuring the forwarding table of each NE along the first best path begins with configuring the forwarding table of the first in-cluster NE and continues with configuring each previous NE until every NE along the first best path is configured.

The method also includes configuring the forwarding table of the second in-cluster NE to forward incoming data to the second storage server (block 361). In some embodiments, this includes configuring the forwarding table of the second in-cluster NE to forward incoming data to a specific storage disk or disk volume the second storage server. The method also includes configuring the forwarding table of each NE in the second subset (of the plurality of NEs in the network) to forward data to the next NE in the second best path. In some embodiments, configuring the forwarding table of each NE along the second best path begins with configuring the forwarding table of the second in-cluster NE and continues with configuring each previous NE until every NE along the second best path is configured.

In one embodiment, the first cluster is the same as the second storage cluster. In such a situation, the first in-cluster NE is also the same as the second in-cluster NE (hereinafter referred to as the “multiple-server in-cluster NE”). If this is the case, but the first storage server is different from the second storage server, then the multiple-server in-cluster NE should be configured to perform multicast or multiple-unicast forwarding of incoming data to both the first storage server and the second storage server (and continuing along a best path if applicable). In some embodiments, the first storage server and second storage server are also the same entity (hereinafter referred to as the “combined storage server”), in which case the multiple-server in-cluster NE should perform multicast forwarding or multiple-unicast forwarding to different storage disks or disk volumes of the combined storage server.

In some embodiments, the second best path may be a subset of the first best path. For example, the first storage server can be storage server 171 and the second storage server can be storage server 161. In this case, case configuring the forwarding table of each NE along the first best path begins with configuring the forwarding table of the first in-cluster NE and continues with configuring each previous NE, including the second in-cluster NE, until every NE along the first best path is configured, which coincidentally also means that every NE along the first best path is configured. For example, if the first storage server is storage server 171, then forwarding table 151 of in-cluster NE 131 will be configured first, then forwarding table 149 of NE 129, then forwarding table 145 of in-cluster NE 125, then forwarding table 143 of NE 123, then forwarding table 141 of NE 121. In this embodiment, the second in-cluster NE ultimately becomes configured to forward data both to the second storage server and to the next NE in the first best path. This configuration of the second in-cluster NE can be a multicast forwarding setup, or can instead include two unicast forwarding setups. For example, if the first storage server is storage server 171 and the second storage server is storage server 161, then the forwarding table 145 of in-cluster NE 125 will be configured such that once the data block reaches in-cluster NE 125, in-cluster NE 125 will forward the data block to both storage server 161 and to NE 129. Though this paragraph describes the second best path as a subset of the first best path, the opposite situation is also possible in another embodiment, where the first best path is a subset of the second best path.

In some embodiments, the forwarding table configurations discussed in blocks 351, 353, 361, and 363 are performed by the cloud manager 101, the network controller 105, or some combination thereof. In one embodiment, the forwarding table configurations are performed by the host tracker 255, the status extractor 257, the data sender 213, or some combination thereof.

The method also includes sending the data block through the first best path and the second best path to be stored in both the first storage server and the second storage server (block 371). The data block is sent from the data source 191 to the first NE in the first best path and the first NE in the second best path. In the embodiment of FIG. 1, the data source 191 only has NE 121 as an entry point to the rest of the network, so in that embodiment, the data source 191 will complete its task by sending the data block to NE 121, whose forwarding table 141 should already have been configured during the processes described in blocks 351, 353, 361, and 363. In some embodiments, the sending of the data block by the data source 191 is initiated by a signal received by the data source 191 from the cloud manager 101, the name node 103, the network controller 105, or some combination thereof. In some embodiments, this signal is sent by the data sender 213, the data tracker 235, the host tracker 255, the status extractor 257, or some combination thereof.

In some embodiments, the method also includes clearing the forwarding table configuration of each of the network elements along the first best path and the second best path after the data block has been stored by the first storage server and the second storage server (block 373). In some embodiments, this clearing may be performed by the cloud manager cloud manager 101, the network controller 105, or some combination thereof. In some embodiments, this clearing may be performed by the data sender 213, the host tracker 255, the status extractor 257, or some combination thereof. In some embodiments, this process involves clearing the entirety of each forwarding table, while in other embodiments, only specific entries relating to the data block are cleared.

There are several benefits of the process described in FIG. 3 over traditional redundant storage processes that do not replicate data using the NEs of a split-architecture network, and instead replicate from one storage server to another. One benefit is that bandwidth usage is more efficient, freeing up network capacity for actual customer traffic, such as map-reduce or search query traffic. For instance, in some traditional redundant storage processes, the same file is copied first to one storage server, then to another storage server, often selecting less efficient paths and often having to send control data to other servers to assist in forwarding the data. Here, paths are planned and forwarding tables are configured ahead of time so that only the required data can be sent, and it must only be sent a single time. Another benefit is that the time of deployment is reduced, allowing the network's distributed file system to be in-service faster than it would have been under a traditional system. In some embodiments, this benefit is due to the centralization of the control plane in the network controller 105 and cloud manager 101, allowing the system's entire control plane to be replaced or upgraded quickly and easily simply by updating the network controller 105, the cloud manager 101, or some combination thereof, without having to modify the NEs.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

FIG. 4A illustrates one exemplary embodiment of data tracking information as viewable by the cloud manager 101 and name node 103. The information is presented in the form of a table, but it can be a different data structure. The table identifies particular data blocks (column 401) against the storage servers that they are located within (column 403).

Here, for example, Data Block A (cell 411) is stored in Storage Server 1 (cell 417), Data Block B (cell 413) is also stored in Storage Server 1 (cell 419), and Data Block C (cell 415) is stored in Storage Server 3 (cell 421). Based on this information, the name-node 103 or cloud manager 101 could determine that Storage Server 2 (not pictured) is empty, and therefore would be the optimal storage server to store an incoming data block.

In some embodiments, the data in the table of FIG. 4A is viewable by the cloud manager 101, the name-node 103, or some combination thereof. In one embodiment, the data in the table of FIG. 4A is viewable by the data tracker 231, the cloud storage identifier 211, the data sender 213, or some combination thereof.

FIG. 4B illustrates one exemplary embodiment of host tracking information as viewable by the cloud manager 101 and network controller 105. The information is presented in the form of a table, but it can be a different data structure. The table identifies particular storage servers (column 405) against the cluster that they are located within (column 407).

Here, for example, Storage Server 1 (cell 423) is stored in Cluster 6 (cell 429), Storage Server 2 (cell 425) is stored in Cluster 4 (cell 431), and Storage Server 3 (cell 427) is also stored in Cluster 6 (cell 433). Based on this information, for example, the cloud manager 101 or the network controller 105 could determine that redundant copies of an incoming data block should be stored in Storage Server 1 and Storage Server 2, rather than in Storage Server 1 and Storage Server 3, to guard against a potential failure of Cluster 6.

In some embodiments, the data in the table of FIG. 4B is viewable by the cloud manager 101, the network controller 105, or some combination thereof. In one embodiment, the data in the table of FIG. 4B is viewable by the host tracker 255, the cloud storage identifier 211, the data sender 213, or some combination thereof.

In one embodiment, the tables of FIG. 4A and FIG. 4B can be combined into a larger combined table that contains information regarding each data block, the storage server the data block is stored in, and the cluster that the storage server is located in. In this embodiment, the name-node 103 and the network controller 105 should be co-located, in communication with each other, or both in communication with the cloud manager 101.

FIG. 4C illustrates one exemplary embodiment of link statistic information as viewable by the cloud manager 101 and network controller 105. The information is presented in the form of a table, but it can be a different data structure.

Here, for example, Link 3 (row 439) is the fastest in both uplink and downlink stats, while Link 2 (row 437) is the slowest in both uplink and downlink stats. Based on this information, for example, the cloud manager 101 or the network controller 105 could determine that the first best path or the second best path should route around NE 3 through NE 4 instead, so that the best path can take advantage of the high speeds of Link 3 as compared to the slow speeds of Link 2.

In some embodiments, the data in the table of FIG. 4C is viewable by the cloud manager 101, the network controller 105, or some combination thereof. In one embodiment, the data in the table of FIG. 4C is viewable by the status extractor 257, the cloud storage identifier 211, the data sender 213, or some combination thereof.

The term “table” is intended to be exemplary rather than restrictive. The tables depicted in FIG. 4A, FIG. 4B, and FIG. 4C can alternately be a data structure such as a database, a list, a matrix, an array, an arraylist, a tree, a hash, a flat file, an image, a queue, a heap, a memory, a stack, a set of registers, or any data structure that can hold data about one or more entities.

In one embodiment, the table of FIG. 4C can be combined with the table of FIG. 4B, the table of FIG. 4A, or even with the “combined” table described in reference to FIG. 4B. Such a table can be combined into a larger combined table that contains link statistics for links between NEs, as well as information about clusters for every in-cluster NE, and information about the storage servers contained in the clusters, and information about the data blocks contains in the storage servers. In this embodiment, the name-node 103 and the network controller 105 should be co-located, in communication with each other, or both in communication with the cloud manager 101.

In some embodiments, the table of FIG. 4C can contain additional link statistic information. For example, the table of FIG. 4C can contain information about link flapping, link stability/volatility, NE firmware/hardware versions, latency, packet loss, link reliability, throughput, link utilization, maximum transmission units (MTU), cost metrics, and similar properties about links in the network.

The embodiments of the tables depicted in FIG. 4A, FIG. 4B, and FIG. 4C are intended to be illustrative and exemplary rather than restrictive. The data displayed within the tables as they are depicted is purely exemplary and not intended as a requirement or a suggestion. Various modifications and changes can be made to the embodiments, including table structure, table columns, use of a different data structure, and similar changes, without departing from the broader spirit and scope of the invention as set forth in the appended claims.

FIG. 5A, FIG. 5B, and FIG. 5C refer to network devices (NDs). A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). In some embodiments, each ND implements a single network element (NE), while in other embodiments, each ND can be used to implement multiple virtual network elements (VNEs).

According to one embodiment, the NEs described above and pictured in FIG. 1 are implemented by NDs.

FIG. 5A illustrates connectivity between NDs within an exemplary network, as well as three exemplary implementations of the NDs, according to some embodiments of the invention. FIG. 5A shows NDs 500A-H, and their connectivity by way of lines (often referred to as “links” between NDs) between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R. In some embodiments, the ND control plane 524 includes the cloud manager 101, the network controller 105, or some combination thereof.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate a hypervisor 554 (sometimes referred to as a virtual machine monitor (VMM)) and one or more virtual machines 562A-R that are run by the hypervisor 554, which are collectively referred to as software instance(s) 552. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 562A-R, and that part of the hardware 540 that executes that virtual machine (be it hardware dedicated to that virtual machine and/or time slices of hardware temporally shared by that virtual machine with others of the virtual machine(s) 562A-R), forms a separate virtual network element(s) 560A-R.

The virtual network element(s) 560A-R perform similar functionality to the virtual network element(s) 530A-R. For instance, the hypervisor 554 may present a virtual operating platform that appears like networking hardware 510 to virtual machine 562A, and the virtual machine 562A may be used to implement functionality similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 562A-R differently. For example, while embodiments of the invention are illustrated with each virtual machine 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 554 includes a virtual switch that provides similar forwarding services as a physical Ethernet switch. Specifically, this virtual switch forwards traffic between virtual machines and the NIC(s) 544, as well as optionally between the virtual machines 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. In some embodiments, such devices can be the data source 191, and their content can be the data block described in FIG. 3. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the virtual machines 562A-R may operate as servers; the same would be true for the hybrid network device 506; in the case of the special-purpose network device 502, one or more such servers could also be run on a hypervisor executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network). In some embodiments, the network illustrated in FIG. 1 is a virtual network or includes a virtual network.

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element (NE) on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A. In some embodiments, the NEs in the network of FIG. 1 are each implemented by a single ND as depicted in FIG. 5D.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506. In some embodiments, the control plane 524 is implemented by the cloud manager 101, the network controller 105, or some combination thereof.

FIG. 5D illustrates that a centralized approach 574 (also known as software defined networking (SDN)) that decouples the system that makes decisions about where traffic is sent from the underlying systems that forwards traffic to the selected destination. The network of FIG. 1 is an SDN. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. In some embodiments, the centralized control plane 576 is implemented by the cloud manager 101, the network controller 105, or some combination thereof. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 105, which includes a centralized reachability and forwarding information module 579 that determines the reachability within the network and distributes the forwarding information to the NEs 570A-H of the data plane 580 over the south bound interface 582 (which may use the OpenFlow protocol). In some embodiments, the host tracker 255 and status extractor 257 are implemented by the centralized reachability and forwarding information module 579. In some embodiments, the network controller 105 is also connected to the data source 191, which is operable to send data through the NEs (depicted illustratively here as connected to NE 570C, though it could be connected to any one of 570A-H). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. In some embodiments, the application(s) 588 include the cloud manager 101. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 105 may also emulate the implementation of multiple VNEs in a single ND. Specifically, instead of (or in addition to) implementing multiple VNEs in a single ND, the network controller 105 may present the implementation of a VNE/NE in a single ND as multiple VNEs in the virtual networks 592 (all in the same one of the virtual network(s) 592, each in different ones of the virtual network(s) 592, or some combination). For example, the network controller 105 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network). In some embodiments, network controller 105 as depicted in FIG. 5D can instead be implemented by cloud manager 101.

On the other hand, FIG. 5E and FIG. 5F respectively illustrate exemplary abstractions of NEs and VNEs that the network controller 105 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices). For example, FIG. 1 and FIG. 2A show the centralized control plane implemented by the cloud manager 101, and FIG. 2B shows the centralized control plane implemented by the cloud manager 101, the network controller 105, or some combination thereof.

Similar to the network device implementations, the electronic device(s) running the centralized control plane 576, and thus the network controller 105 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates a general purpose control plane device 604 including hardware 640 comprising a set of one or more processor(s) 251 (which are often COTS processors) and network interface controller(s) 644 (NICs; also known as network interface cards) (which include physical NIs 646), as well as non-transitory machine readable storage media 253 (or in some embodiments, 203) having stored therein centralized control plane (CCP) software 650. In some embodiments, hardware 640 is implemented by the hardware of the cloud manager 101, the network controller 105, or some combination thereof. In some embodiments, processor(s) 641 are implemented by processor 201, processor 251, or some combination thereof. In some embodiments, non-transitory machine readable storage media 253 (or in some embodiments, 203) is implemented by data store 203, data store 253, or some combination thereof.

In embodiments that use compute virtualization, the processor(s) 251 typically execute software to instantiate a hypervisor 654 (sometimes referred to as a virtual machine monitor (VMM)) and one or more virtual machines 662A-R that are run by the hypervisor 654; which are collectively referred to as software instance(s) 652. A virtual machine is a software implementation of a physical machine that runs programs as if they were executing on a physical, non-virtualized machine; and applications generally are not aware they are running on a virtual machine as opposed to running on a “bare metal” host electronic device, though some systems provide para-virtualization which allows an operating system or application to be aware of the presence of virtualization for optimization purposes. Again, in embodiments where compute virtualization is used, during operation an instance of the CCP software 650 (illustrated as CCP instance 676A) on top of an operating system 664A are typically executed within the virtual machine 662A. Network controller instance 105 need not run on each VM instance 662A-662R. In some embodiments, software instance 652 could include an OS instance underneath (not pictures) for type-2 hypervisor, on which hypervisor 654 would ride. In embodiments where compute virtualization is not used, the CCP instance 676A on top of operating system 664A is executed on the “bare metal” general purpose control plane device 604. In some embodiments, the control manager 101, the name-node 103, the network controller 105, or the data source 191 are virtualized using a hypervisor in this manner.

The operating system 664A provides basic processing, input/output (I/O), and networking capabilities. In some embodiments, the CCP instance 676A includes a network controller instance 105. The network controller instance 105 includes a centralized reachability and forwarding information module instance 679 (which is a middleware layer providing the context of the network controller 105 to the operating system 664A and communicating with the various NEs), and an CCP application layer 680 (sometimes referred to as an application layer) over the middleware layer (providing the intelligence required for various network operations such as protocols, network situational awareness, and user—interfaces). In some embodiments, the host tracker 255 and status extractor 257 are implemented by the centralized reachability and forwarding information module instance 679. At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables. The forwarding table configurations described in block 351, block 353, block 361, and block 363 of FIG. 3 are performed using such messages according to some embodiments.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched or based on priority associated with flow/group). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet. This is how the data block eventually reaches the first storage server and second storage server after traveling through the NEs as described in block 371 of FIG. 3 according to some embodiments.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed (e.g., reactive flows or proactive flows) into the data plane 580 by the centralized control plane 576, the next packet with matching credentials will match that forwarding table entry and take the set of actions associated with that matched entry.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) (RFC 2991 and 2992) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down. In some embodiments, ECMP is used during the processes described in block 323, block 331, and block 333 of FIG. 3.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths. In some embodiments, the links between NEs in FIG. 1 are L3 LAG links

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic. In some embodiments, the data source 191 is authenticated using AAA protocols prior to sending the data block as described in block 371 of FIG. 3.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking) For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures can be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for redundant storage of a data block from a data source across a plurality of storage servers in a distributed file system implemented by a cloud manager system within a programmable or software-defined network, wherein the network contains a plurality of network elements (NEs) and a plurality of clusters, wherein each cluster includes a subset of the plurality of storage servers and an in-cluster NE that is coupled to each of the subset of storage servers in the cluster, wherein the cloud manager communicates with the NEs using a split architecture protocol, the method comprising:
identifying a first storage server and a second storage server in the network, wherein the first storage server and the second storage server have sufficient storage space to store the data block;
identifying a first cluster and a second cluster in the network, such that the first cluster includes the first storage server and a first in-cluster NE, and the second cluster includes the second storage server and a second in-cluster NE;
calculating a first best path from the data source to the first in-cluster NE, through a first subset of the plurality of NEs in the network;
calculating a second best path from the data source to the second in-cluster NE, through a second subset of the plurality of NEs in the network;
reserving bandwidth along the first and second best paths for the data block to be sent;
configuring the forwarding table of the first in-cluster NE to forward incoming data to the first storage server;
configuring the forwarding table of each NE in the first subset to forward data to the next NE in the first best path;
configuring the forwarding table of the second in-cluster NE to forward incoming data to the second storage server;
configuring the forwarding table of each NE in the second subset to forward data to the next NE in the second best path; and
sending the data block through the first best path and the second best path to be stored in the first storage server and the second storage server.

2. The method of claim 1, further comprising:
preparing a storage server in the network by installing a background process to be executed by the storage server.

3. The method of claim 1, further comprising:
clearing the forwarding table configuration of each of the NEs along the first best path and the second best path after the data block has been stored by the first storage server and the second storage server.

4. The method of claim 1, wherein the second best path is a subset of the first best path, and configuring the forwarding table of the second in-cluster NE includes configuring the second in-cluster NE to forward the data block to the second storage server and also to the next NE in the first best path.

5. The method of claim 4, wherein configuring the forwarding table of each NE along the first best path begins with configuring the forwarding table of the first in-cluster NE and continues with configuring each previous NE, including the second in-cluster NE, until every NE along the first best path is configured.

6. The method of claim 1, wherein calculating the first best path and second best path includes examining, for each NE in the network, an uplink statistic and a downlink statistic of the network links going into and out of the NE.

7. The method of claim 1, wherein the first cluster and the second cluster are the same cluster, and wherein the first in-cluster NE and the second in-cluster NE are the same NE.

8. The method of claim 1, wherein the cloud manager is an application running on a guest operating system above a hypervisor, and further wherein the hypervisor is one of (a) a bare metal hypervisor running natively on a server, or (b) a hypervisor running on top of a base operating system.

9. A non-transitory machine-readable storage medium that stores instructions that, if executed by a processor of a cloud manager system, the cloud manager system used for redundant storage of a data block from a data source across a plurality of storage servers in a distributed file system within a programmable or software-defined network, wherein the network contains a plurality of network elements (NEs) and a plurality of clusters, wherein each cluster includes a subset of the plurality of storage servers and an in-cluster NE that is coupled to each of the subset of storage servers in the cluster, wherein the cloud manager communicates with the NEs using a split architecture protocol, will cause said processor to perform operations comprising:
identifying a first storage server and a second storage server in the network, wherein the first storage server and the second storage server have sufficient storage space to store the data block;
identifying a first cluster and a second cluster in the network, such that the first cluster includes the first storage server and a first in-cluster NE, and the second cluster includes the second storage server and a second in-cluster NE;
calculating a first best path from the data source to the first in-cluster NE, through a first subset of the plurality of NEs in the network;
calculating a second best path from the data source to the second in-cluster NE, through a second subset of the plurality of NEs in the network;
reserving bandwidth along the first and second best paths for the data block to be sent;
configuring the forwarding table of the first in-cluster NE to forward incoming data to the first storage server;
configuring the forwarding table of each NE in the first subset to forward data to the next NE in the first best path;
configuring the forwarding table of the second in-cluster NE to forward incoming data to the second storage server;
configuring the forwarding table of each NE in the second subset to forward data to the next NE in the second best path; and
sending the data block through the first best path and the second best path to be stored in the first storage server and the second storage server.

10. The non-transitory machine-readable storage medium of claim 9, the operations further comprising:
preparing a storage server in the network by installing a background process to be executed by the storage server.

11. The non-transitory machine-readable storage medium of claim 9, the operations further comprising:
clearing the forwarding table configuration of each of the NEs along the first best path and the second best path after the data block has been stored by the first storage server and the second storage server.

12. A cloud manager system for redundant storage of a data block from a data source across a plurality of storage servers in a distributed file system, the cloud manager system within a programmable or software-defined network, wherein the network contains a plurality of network elements (NEs) and a plurality of clusters of storage servers, wherein each cluster is coupled to an in-cluster NE, wherein the cloud manager communicates with the NEs using a split architecture protocol, the cloud manager system comprising:
a data store;
a processor coupled to the data store, the processor operable to execute a cloud storage identifier, the cloud storage identifier operable to identify a first storage server and a second storage server in the network, wherein the first storage server and the second storage server have sufficient storage space to store the data block, and to identify a first cluster and a second cluster in the network, such that the first cluster includes the first storage server and a first in-cluster NE, and the second cluster includes the second storage server and a second in-cluster NE, the processor further operable to execute a data sender, the data sender operable to calculate a first best path from the data source to the first in-cluster NE, through a first subset of the plurality of NEs in the network, the data sender further operable to calculate a second best path from the data source to the second in-cluster NE, through a second subset of the plurality of NEs in the network, the data sender further operable to reserve bandwidth along the first and second best paths for the data block to be sent, the data sender further operable to configure the forwarding table of the first in-cluster NE to forward incoming data to the first storage server, the data sender further operable to configure the forwarding table of each NE in the first subset to forward data to the next NE in the first best path, the data sender further operable to configure the forwarding table of the second in-cluster NE to forward incoming data to the second storage server, the data sender further operable to configure the forwarding table of each NE in the second subset to forward data to the next NE in the second best path, the data sender further operable to send the data block through the first best path and the second best path to be stored in the first storage server and the second storage server.

13. The system of claim 12, wherein the processor either executes or accesses via a network a name node, the name node being a name node of a distributed file system, the name node containing a name node processor, the name node processor operable to execute a data tracker, the data tracker operable to identify which of the storage servers in the network contains a particular data block.

14. The system of claim 12, wherein the processor either executes or accesses via a network a network controller, the network controller being a network controller of the software-defined network, the controller containing a controller processor, the controller processor operable to execute a host tracker, the host tracker operable to identify a path through the NEs in the network to reach any one of the storage servers, the controller processor further operable to execute a status extractor, the status extractor operable to track an uplink and a downlink statistic for the links between each pair of NEs in the network.

15. The system of claim 12, wherein the processor is further operable to execute a network preparer, the network preparer operable to prepare a storage server in the network by installing a background process to be executed by the storage server.

16. The system of claim 12, wherein the data sender is further operable to clear the forwarding table configuration of each of the NEs along the first best path and the second best path after the data block has been stored by the first storage server and the second storage server.

17. The system of claim 12, wherein the data sender calculates the second best path to be a subset of the first best path, and wherein the data sender configures the forwarding table of the second in-cluster NE to forward the data block to the second storage server and also to the next NE in the first best path.

18. The system of claim 12, wherein the data sender configures the forwarding table of each NE along the first best path by first configuring the forwarding table of the first in-cluster NE, then by configuring each previous NE until every NE along the first best path is configured, and further wherein the data sender configures the forwarding table of each NE along the second best path by first configuring the forwarding table of the second in-cluster NE, then by configuring each previous NE until every NE along the second best path is configured.

19. The system of claim 12, wherein the data sender is further operable to examine, for each network link between each pair of NEs in the network, an uplink statistic and a downlink statistic, and to use the statistics to determine a fastest path to reach the first in-cluster NE and the second in-cluster NE.

20. The system of claim 12, wherein the first cluster and the second cluster are the same cluster, and wherein the first in-cluster NE and the second in-cluster NE are the same NE.

21. The system of claim 12, wherein the cloud manager is an application running on a guest operating system above a hypervisor, and further wherein the hypervisor is one of (a) a bare metal hypervisor running natively on a server, or (b) a hypervisor running on top of a base operating system.
